(19) United States
(12) Patent Application Publication
(10) Pub. No.: US 2011/0113125 A1
(43) Pub. Date: May 12, 2011

(54) METHOD FOR DETERMINING A DATA FORMAT FOR PROCESSING DATA AND DEVICE EMPLOYING THE SAME

(75) Inventors: David Novo Bruna, Barcelona (ES); Bruno Bougard, Jodolgne (BE)

(73) Assignees: IMEC, Leuven (BE); Katholieke Universiteit Leuven, Leuven (BE)

(21) Appl. No.: 12/876,914

(22) Filed: Sep. 7, 2010

Related U.S. Application Data
(63) Continuation of application No. PCT/EP2009/001616, filed on Mar. 6, 2009.
(60) Provisional application No. 61/034,854, filed on Mar. 7, 2008.

(51) Int. Cl. G06F 15/177

(52) U.S. Cl. 709/220

(57) ABSTRACT

A method for determining a data format for processing data to be transmitted along a communication path is disclosed. In one aspect, the method includes identifying at run-time an operational configuration based on received information on the conditions for communication on the communication path. The method may also include selecting according to the identified operational configuration, a data format for processing data to be transmitted among a plurality of predetermined data formats.

### CROSS-REFERENCE TO RELATED APPLICATIONS

This application is a continuation of PCT Application No. PCT/EP2009/001616, filed Mar. 6, 2009, which claims priority under 35 U.S.C. §119(e) to U.S. provisional patent application 61/034,854 filed on Mar. 7, 2008. Each of the above applications is incorporated herein by reference in its entirety.

### BACKGROUND OF THE INVENTION

1. Field of the Invention

The present invention generally relates to the field of data format selection in communication devices.

2. Description of the Related Technology

Wireless technology is considered as a key enabler of many future consumer products and services. To cover the extensive range of applications, future handhelds will need to concurrently support a wide variety of wireless communication standards. The growing number of air interfaces to be supported makes traditional implementations based on the integration of multiple specific radios and baseband ICs cost-ineffective and claims for more flexible solutions. Software defined radios (SDR), where the baseband processing is deployed on a programmable or reconfigurable hardware, has been introduced as the ultimate way to achieve flexibility and cost-efficiency.

In handhelds, energy efficiency is a major concern as they are battery operated devices. The multi-mode trend adds extra needs for programmability, which may reduce the platform energy efficiency. The energy efficiency of SDR baseband is therefore a major concern. Thus there exists a challenge to design programmable handhelds (SDR requirement) that are still energy efficient (terminal requirement). New processor architectures with major improvements on energy efficiency (GOPS/mW) are emerging but are still not sufficient to catch the continuously increasing complexity of wireless physical layers within the shrinking energy budget. To enable SDR in size, weight and power constrained devices, innovation is also needed at the software side. Specifically, a thorough architecture-aware algorithm implementation approach is needed for the baseband signal processing functions, which account for a substantial portion of the SDR computational complexity. A key feature of such an approach is to enable implementations where the computation load and the related power consumption can scale and adapt to the instantaneous environment and user requirements. In this way the average power consumption can greatly be reduced.

To date, several SDR platforms have been proposed in academia and industry. Most of these platforms support the execution of wireless standards such as WCDMA (UMTS), IEEE 802.11b/g, IEEE 802.16. However, a key challenge still resides in the instantiation of such programmable architectures capable of coping with the 10× increase both in complexity and in throughput required by next-generation standards relying on multi-carrier and multi-antenna processing (IEEE 802.11n, 3GPP LTE), still being cost effective. Leveraging on the sole technology scaling is not sufficient anymore to sustain the complexity increase. In order to achieve the required high performance at an energy budget acceptable for handheld integration (˜300 mW), architectures must be revisited keeping in mind the key characteristics of wireless baseband processing: high and dynamic data level parallelism (DLP) and data flow dominance.

In nowadays SDR platforms, very long instruction word (VLIW) processors with SIMD (single instruction-multiple data) functional units are often considered to exploit the data level parallelism with limited instruction fetching overhead. In other approaches, data flow dominance is sometimes exploited in coarse-grained reconfigurable arrays (CGA). The first class of architectures have tighter limitations in achievable throughput for a given clock frequency while the second class has as main disadvantage to require very low level programming.

Besides in computer architectures, innovation is also needed in the way baseband processing is handled in software, which is strongly linked with signal processing. Typically, baseband signal processing algorithms are designed and optimized with a dedicated hardware (ASIC) implementation in mind, which requires regular and manifest computation structures as well as simple control flow, maximum functional blocks reuse and minimum data word width. Programmable architectures have other requirements. Typically, they can accommodate more complex control flows. Functional reuse is not a must since not the entire area but only the instruction memory footprint benefits from it. However, they have more limitations in terms of maximal computational complexity and energy efficiency. Moreover, data types must be aligned. Taking these characteristics into account when developing the baseband algorithms is key to enable energy-efficient SDRs.

The presence of highly dynamic operative conditions in baseband digital signal processing leads to an unaffordable overhead when the typical static worst-case dimensioning approach is considered. The combination of both energy-scalable algorithm implementation and adaptive performance/energy management turns out to enable high energy efficiency as it has the potential to continuously best-fit the dynamic behaviours. When applied at algorithmic level solely, with relatively direct implementation, this approach allows one to save up to 60% of the average execution time on the DSP at negligible system performance loss, as mentioned in “Quality-Cost Scalable Chip Level Equalizer in HSDPA Receiver” (Min Li et al., Globecom '06. San Francisco”.

Similarly, but at a lower implementation level, data formats can exploit the signal range and precision dynamics to offer different trade-offs between computation accuracy and energy consumption. In communication signal processing systems, I/O correctness does not need to be preserved in the strict sense. Approximations can generally be accommodated while maintaining the desired system performance, as communication algorithms can still function under different signal-to-noise ratio (SNR) conditions. However, this tolerance to inaccuracy is dependent on the system working conditions. For instance, processing the equalization and demodulation of a signal modulated with a high order constellation may require higher accuracy than in the case of a low order one. In order to reach scalability this accuracy adjustment can be performed separately for different use-cases or scenarios. Certainly, these scenarios should be sufficiently easy to detect/distinguish at run-time.

Finite word-length refinement for data format selection has been an active research field for more than 30 years. Traditionally, most contributions have focused on the development of methods and tools that automatically convert a floating-point spec into an optimal fixed-point representation under a given user-defined quantization noise to signal ratio (QNSR). Most of the existing work on this area agrees on splitting the optimization problem in two steps: range analysis and precision analysis. The range analysis provides the margin to accommodate the growth of the data (avoiding overflow), whereas the precision analysis guarantees the accuracy of the operations. For both, range and precision analysis, dynamic and static analysis methods have been proposed. Firstly, the dynamic analysis methods, also called simulation based methods, evaluate the data-flow graph (DFG) of the design using representative input signals. Secondly, the static analysis methods, also called analytical methods, propagate statistic characteristics of the inputs through the DFG. Finally, hybrid approaches have been proposed, which aim to combine the advantages of both the static and dynamic methods.

This previous work assumes that the data format assignment is performed under worst-case conditions at design-time, which would lead to sub-optimal solutions under the highly dynamic operating conditions of the SDR context considered here. Alternatively, Yoshizawa proposes in “Tunable Wordlength Architecture for a Low Power Wireless OFDM Demodulator” (ISCAS '06, Kos, Greece (2006)) a word-length tunable VLSI architecture for a wireless demodulator that dynamically changes its own word length according to the communication environment. The word-length selection is done at run-time depending on the observed error vector magnitude from demodulated signals. The word length is tuned to satisfy required quality of communication. This approach saves up to 30% of the power. However it assumes a dedicated hardware implementation and requires the addition of a special field (containing the known sequence used to estimate the current quantization error) into the transmission packet format. The latter jeopardizes its implementation in standard-compliant systems.

Application EP1873627 relates to a processor architecture for multimedia applications that includes a plurality of processor clusters providing vectorial data processing capability. The processing elements in the processor clusters are configured to process both data with a given bit length N and data with bit lengths N/2, N/4, and so on obtainable by portioning the bit length N according to a single instruction multiple data (SIMD) paradigm. However, no indication is given to the use of the technique in a telecommunication application.

### SUMMARY OF CERTAIN INVENTIVE ASPECTS

Certain inventive aspects relate to a method for data format refinement suitable for use in energy-scalable communication systems, and further to a device that operates in accordance with the proposed method.

One inventive aspect relates to a method for determining a data format for processing data to be transmitted along a communication path. The method comprises a) identifying at run-time an operational configuration based on received information on the conditions for communication on the communication path, and b) selecting according to the identified operational configuration, a data format for processing data to be transmitted among a plurality of predetermined data formats.

In one embodiment the process of identifying comprises mapping the identified operational configuration to one of a predetermined set of operational modes and the data format is selected corresponding to the operational mode to which the operational configuration is mapped.

Preferably the method comprises the process of transmitting the data in the selected data format.

In one embodiment the method comprises the further process of determining the information on the communication conditions on the communication path.

The selected data format advantageously determines the word length of words in the data.

The selected data format preferably determines the fixed-point representation of the data.

The process of identifying the varying noise-robustness is advantageously taken into account exhibited by an application wherein the data is used.

One inventive aspect also relates to the use of the method as previously described, whereby the processing is performed on a single instruction multiple data processor.

In another aspect the invention relates to a communication device for transmitting data along a communication path. The device is arranged for identifying at run-time an operational configuration based on received information on the communication conditions on the communication path. The device comprises selection means for selecting according to the identified operational configuration a data format for transmitting data among a plurality of predetermined data formats.

In one embodiment the communication device further comprises a single instruction multiple data processor. In another preferred embodiment the device comprises a hybrid single instruction multiple data-coarse grain array processor.

### BRIEF DESCRIPTION OF THE DRAWINGS

FIG. 1 represents a flow chart of the method according to one embodiment.

FIG. 2 represents the processor top level architecture.

FIG. 3 represents the processor core architecture.

FIG. 4 represents a block diagram of the OFDM receiver considered, with the implemented blocks highlighted.

FIG. 5 illustrates a diagram of the ADRES instance considered.

FIG. 6 illustrates BER curves of the SISO BPSK ½, before (solid) and after (dashed) fixed-point refinement (left) and its BER degradation as function of the data word length (right).

FIG. 7 illustrates throughput curves of different receiver modes.

FIG. 8 represents curves of the SISO throughput performance (a) and energy consumption (b).

FIG. 9 represents curves of the SDM throughput performance (a) and energy consumption (b).

FIG. 10 shows a block diagram illustrating one embodiment of a communication device for transmitting data along a communication path.

### DETAILED DESCRIPTION OF CERTAIN ILLUSTRATIVE EMBODIMENTS

Certain aspects of the invention relate to an industry compatible approach to exploit the variations on the instantaneous minimum required precision in an energy-scalable manner, without compromising the standard compliance of the implementation. This is achieved by partially porting the data format decisions to the run-time in a scenario-based manner. Multiple design-time implementations of the same functionality with different precision, corresponding to specific use-cases or scenarios, are optimized separately and selected by a simple controller at run-time. The latter decides which implementation is more efficient given the current conditions. This technique does not depend on the selected fixed-point refinement approach (dynamic vs. static) but considers the application knowledge (through the scenario definition) to effectively guide the refinement process.

In state of the art design methodologies, data formats are typically dimensioned at design-time. This dimensioning aims to satisfy the application requirements under all the possible operating conditions. As an alternative, a scenario-oriented data format refinement, which consists of a hybrid design-/run-time approach, is proposed. In that approach, situations/scenarios where the application exhibits a different tolerance to the quantization noise are identified. Accordingly, separated fixed-point refinements are performed for each of these scenarios, resulting in multiple software implementations. At run-time, the actual scenario that best suits the current working conditions is detected and the corresponding implementation is selected by a simple controller.

Scenarios where the application exhibits a different tolerance to the noise are very common in communication systems as the channel is considered as an unpredictable source of noise and attenuation. The degree of uncertainty is especially important in wireless communications, where the system has to deal with widely varying signal to noise ratio. Besides the distance between transmitter and receiver, other random physical phenomena, such as multipath fading, can also seriously affect the received SNR.

As an example, OFDM systems, when used in the context of wireless communications (e.g. IEEE 802.11 family), are designed to provide several trade-offs between data rate and coverage. Accordingly, they offer various operational modes by implementing different combinations of sub-carrier modulation scheme and coding rate. The modulation scheme defines the amount of bits that are grouped together and transmitted on a fixed amount of sub-carriers (e.g. 1 bit per subcarrier for BPSK, 2 for QPSK, 4 for 16QAM and 6 for 64QAM) and thus importantly impacts the physical data rate. The coding rate determines the amount of redundancy added to the transmitted bit-stream to enable forward error correction (FEC) to be performed at the receiver. This recovers transmission errors by collecting time and frequency diversity. Reducing the modulation order or/and reducing the code rate decreases the data rate but improves the robustness of the system to the noise and attenuation.

One inventive aspect is to take the varying noise-robustness exhibited by the application into consideration when performing fixed-point refinement. It is capitalized on the fact that the extra degradation that would be introduced by moving to a cheaper fixed-point implementation may be tolerated in many situations.

Typically, the quantization of a signal is modelled by the sum of this signal and a random variable. This additive noise is a stationary and uniformly distributed white noise that is not correlated with the signal and with the other quantization noises. Thus, the effect of refining an ideal (infinite precision) linear time-invariant algorithm into a fixed-point implementation can be modelled as the initial algorithm of ideal operators fed with the sum of the ideal operands and a noise component (quantization noise). In order to extend the analysis for linear, time-invariant systems applicable to non-linear systems, the first step is the linearization of these systems. The assumption is made that the quantization errors induced by rounding or truncation are sufficiently small not to affect the macroscopic behaviour of the system. Under such circumstances, each component in the system can be locally linearized. As a result, the quantization noise can be forward propagated towards the inputs of the algorithm and be assumed to belong to the channel. Consequently, the transmission modes that tolerate higher levels of channel noise in the received signal should also be able to accept higher levels of quantization noise on their processing. These modes will require fewer bits to maintain the necessary accuracy.

In one of the proposed methods, the following steps are carried out:
Floating point simulation of the communication system for the different possible configurations. In this simulation the performance curve of the different configurations is extracted for a range of received SNR.
Fixed-point refinement of each configuration for its working SNR (SNR point from which the performance of the system saturates).
Clustering of different configurations into the same implementation when having similar word lengths
Finally, a controller needs to track the environmental conditions, identify the current scenario and react by selecting the most efficient implementation. The overhead introduced by this controller needs to be kept low in order to maximize the benefits given by the splitting of the application into different optimized scenarios.

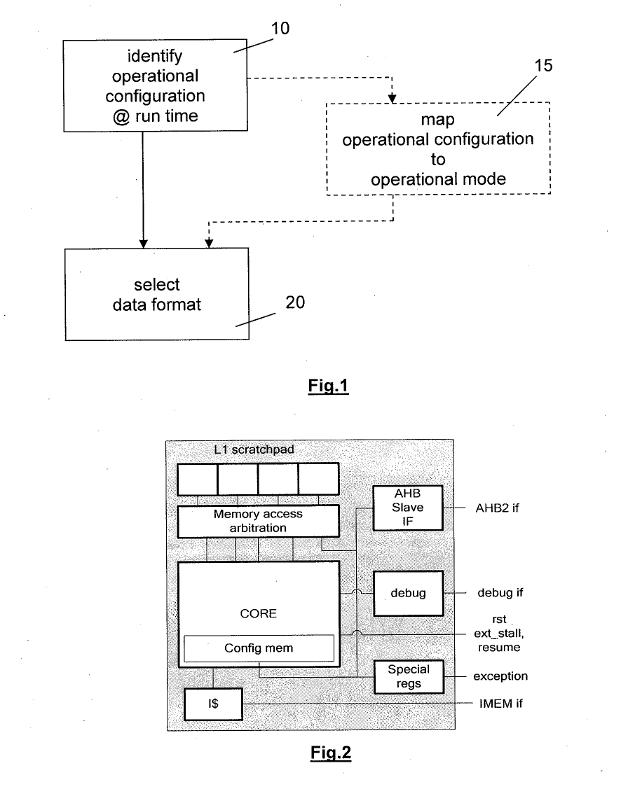

FIG. 1 illustrates the main steps of the method for determining a data format for processing data to be transmitted along a communication path according to one embodiment. At run time an operational configuration is identified based on received information on the conditions for communication on the communication path (step 10). Optionally, the operational configuration as identified is mapped to an operational mode of a set of modes in step 15. According to the identified operational configuration or to the operational mode to which that operational configuration is mapped, a data format for processing data to be transmitted is selected among a plurality of predetermined data formats in step 20.

In one embodiment, the single instruction multiple data (SIMD) architecture paradigm is leveraged to achieve reduced execution time and energy for lower precision fixed-point implementations. In particular, the fact is exploited that multiple data (sub-words) can be packed together and operated on as a single word. The size of these sub-words is variable and can be selected from a discrete set, typically of powers-of-2. The different sub-word configurations share the same hardware operators, which are configured depending on the current sub-word size. The result is called a sub-word parallel instruction-set data path. This embodiment is also applicable to pure vector processors (with fixed sub-word size) which form the other SIMD class. The execution time and energy costs associated with the operation (operand load, execution, result storage) is shared by all the sub-words. Consequently, the fewer bits that are required to represent the data, the more data can be packed together and the cheaper the processing per sub-word becomes.

In another preferred embodiment a hybrid CGA-SIMD processor is considered to map the different fixed point implementations. The latter conjugates the advantages of a SIMD data-path, which fits the high data level parallelism present in the application and enable certain embodiments, with a CGA architecture, which is leveraged to exploit the dataflow dominance and the remaining (not data dominated) application parallelism.

A possible instance of such a hybrid CGA-SIMD processor can be built based on the ADRES framework. In this specific case, the processor is programmable from C-language, capitalizing on the DRESC CGA compiler.

As an example, to sustain further description of certain embodiments, the design of a specific instance of the C-programmable hybrid CGA-SIMD processor is presented. It will be apparent to those skilled in the art that the invention is not limited to the details of this illustrative embodiments, and that the present invention may be embodied with various changes and modifications without departing from the spirit and scope thereof.

### Processor Architecture

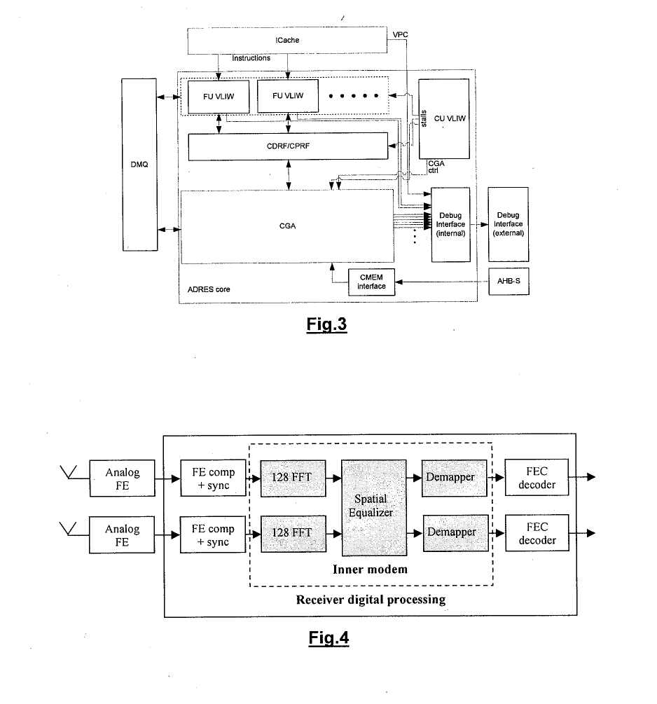

The processor is designed to serve mainly as slave in multi-core SDR platforms. The top level block diagram is depicted in FIG. 2. The processor has an asynchronous reset, a single external system clock and a half-speed (AMBA) bus clock. Instruction and data flow are separated (Harvard architecture). A direct-mapped instruction cache (I$) is implemented with a dedicated 128-bit wide instruction memory interface. Data is fetched from an internal 4-bank 1-port-per-bank 16K×32-bit scratchpad (L1) with 5-channel crossbar and transparent bank access contention logic and queuing. The L1 is accessible from external through an AMBA-compatible slave bus interface.

The core of the processor is made of a plurality of densely interconnected SIMD functional units with global and distributed register files. The CGA is associated with the multi-bank data scratchpad (L1) and provides an AMBA interface for configuration and data exchange. Besides, three functional units, operating as VLIW and sharing the global register file.

The processor can execute according to two modes. When in so-called VLIW mode, the VLIW units can execute C-compiled non-kernel code fetched through the instruction cache. When in CGA mode, C-compiled DSP kernels are executed on the CGA units while keeping configurations in local memories that are configured through direct memory access (DMA). Per scheduled loop cycle, one context is read from the configuration memories. The CGA configuration memories and special registers are also mapped to the AMBA bus interface via a 32-bit internal bus.

The DRESC framework can be used to transparently compile a single C language source code to both the VLIW and the CGA machines.

At the peripheral, the processor has a level-sensitive control interface with configurable external endianness and AMBA priority settings (settable priority between core and bus interface to access L1), exception signaling, external stall and resume input signals. Because of the large state, the processor is not interruptible when in CGA mode. The external stall and resume signals provide however an interface to work as a slave in a multi-processor platform. The first is used to stop the processor while maintaining the state (e.g. to implement flow control at SOC level). Internally, a special stop instruction can be issued that sets the processor in an internal sleep state, from which it can recover at assertion of the resume signal. The data scratchpad and special register bank stay accessible through the AMBA interface in sleep mode.

A detailed view of a possible physical implementation of the core-level architecture is depicted in FIG. 3. The core is mainly made of a Global Control Unit (CGU), 3 predicated VLIW Functional Units (FU), the CGA module and a 6-read/3-write ports 64×32-bit Central Data and 64×1-bit Predicate Register File (CDRF/CPRF).

VLIW and CGA operate the CDRF/CPRF in mutual exclusion and hence its ports are multiplexed. This shared register file naturally enables the communication between the VLIW and the CGA working modes. The two modes often need to exchange data as the CGA executes data-flow dominated loops while the rest of the code is executed by the VLIW.

In this specific implementation, the CGA is made of 16 interconnected units from which 3 have a two-read/one-write port to the global data and predicate register files. The others have a local 2-read/1-write register file.

These local registers are less power hungry than the shared one due to their reduced size and number of ports. The execution of the CGA is controlled by a small size ultra wide configuration memory. The latter extends the instruction buffer approach, so common in VLIW architectures, to the CGA. On this way the CGA instruction fetching power is importantly reduced. VLIW and CGA functional units have SIMD data-paths. The supported functionality is distributed over several different instruction groups. Several dedicated instruction are used to control the SIMD operations.

### Example

### Multi-Antenna OFDM Receivers for Next Generation WLAN

To illustrate the validity of the proposed scenario-based method for adaptive fixed-point refinement and its embodiment in the context of the proposed hybrid SIMD-CGA architecture, the example of a high-rate OFDM receiver is presented.

Wireless communication systems must generally deliver 10× more data rate from generation to generation. In Wireless LAN (local area network) systems in particular, this data rate increase can be achieved by leveraging on multiple antenna transmission techniques, especially on the so-called space division multiplexing (SDM). In SDM, multiple independent data streams are transmitted in the same frequency band at the same time through different antennas. Accordingly, the system data rate grows about linearly with the number of parallel data streams.

A two-antennas SDM transceiver is considered which combines two adjacent 20 MHz channels into a single 40 MHz one (channel bonding). This configuration enables data rates higher than 200 Mbps. FIG. 4 shows the block diagram of the receiver. The fast Fourier transform (FFT) together with the Spatial Equalizer and the demapper constitute the so-called inner modem. The FFT block processes vectors of 128 complex elements. The spatial equalizer cancels out the channel distortion and the inter-stream interference. A minimum mean square error (MMSE) filter is implemented therefore. Finally, the demapper translates the constellation symbols into bits.

This application exhibits no data-dependent execution. Moreover the processing is block-based, meaning that it continuously performs the same operations over blocks of 128 carriers (OFDM symbol). These two characteristics, together with a relaxed latency constraint (present in the transmission of long packets), enable block-based SIMD processing. This means that carriers belonging to consecutive OFDM symbols are packed together in a single word. Thus, the addition of a new sub-word into the original word just implies the buffering of another symbol while the control flow remains identical. This technique leads to a negligible SIMD overhead since the input buffer is already present in typical wireless architectures notably for synchronization purposes. The data shuffling required is minimal. Consequently, by doubling the amount of sub-words packed into a word one can expect about to halve the average energy and execution time.

Before any fixed-point refinement, the selected wireless system is simulated under ideal precision conditions for the different receiver modes. This is illustrated in Table 1, which shows the minimum SNR required for achieving a bit error ratio (BER) of 10⁻³ for the different operation modes. The level of noise that guarantees a certain transmission performance, such as a BER below 10⁻³, interestingly varies depending on the selected mode.

TABLE I

| | # | mod. | cod. | SNR [dB] |
|---|---|---|---|---|
| mode | ant. | scheme | rate | BER = 10⁻³ |
| 1 | 1 | BPSK | 1/2 | 3.0 |
| 2 | 1 | BPSK | 3/4 | 7.5 |
| 3 | 1 | QPSK | 1/2 | 6.5 |
| 4 | 1 | QPSK | 3/4 | 10.5 |
| 5 | 1 | 16QAM | 1/2 | 12.5 |
| 6 | 1 | 16QAM | 3/4 | 25.5 |
| 7 | 1 | 64QAM | 2/3 | 20.5 |
| 8 | 1 | 64QAM | 3/4 | 22.3 |
| 9 | 2 | BPSK | 1/2 | 5.5 |
| 10 | 2 | BPSK | 3/4 | 10.5 |
| 11 | 2 | QPSK | 1/2 | 11.5 |
| 12 | 2 | QPSK | 3/4 | 16.5 |
| 13 | 2 | 16QAM | 1/2 | 18.0 |
| 14 | 2 | 16QAM | 3/4 | 25.5 |
| 15 | 2 | 64QAM | 2/3 | 31.0 |
| 16 | 2 | 64QAM | 3/4 | 34.0 |

The application is prepared to be mapped on the aforementioned hybrid SIMD-CGA processor. The compiler automatically achieves high instruction level parallelism (ILP). In contrast, the data level parallelism (DLP) can be handled by the programmer via intrinsic C functions.

The processor instance considered throughout the example (see FIG. 5), consists on a 4×4 array of 32 bit FUs. These units provide traditional DSP functionality extended with an extensive SIMD support. Table II lists some of the Instruction Set Architecture (ISA) extensions included to exploit 2-ways SIMD. The inputs (src1 and src2) and the output (dst) contain 2 concatenated sub-words, indicated with a final R and I. Similarly, the implemented ISA also includes 4-ways and 8-ways SIMD so it is sub-word parallel. Note again, that one can also use other sub-word parallel processors as target.

TABLE II

| Instr | Description | Pseudo code |
|---|---|---|
| cadd | complex | dstR = src1R + src2R |
| | addition | dstI = src1I + src2I |
| csub | complex | dstR = src1R − src2R |
| | subtraction | dstI = src1I − src2I |
| cshftr | complex right | dstR = src1R >> src2 |
| | shifter | dstI = src1I >> src2 |
| dprod | dot product | dstR = src1R * src2R |
| | | dstI = src1I * src2I |

A simulation-based approach is applied to cover the fixed-point data format refinement process. This can easily propagate the degradation introduced by the finite precision signals to the high-level performance metrics such as BER. In order to enable a fixed-point simulation, the signals of the initial floating-point description are instrumented. This is done by including a set of functions in the initial code which have as input the original floating-point signal and outputs a fixed-point representation. The conversion is controlled with a set of parameters. The total number of bits per signal, the number of decimal bits, the quantization mode (round or truncation) and the overflow mode (wrap-around or saturation) are the most important parameters. After giving a value to those parameters, the entire communication chain can be simulated with fixed-point precision. Consequently, the impact on the application performance of the selected fixed-point configuration (given by the set of values introduced in the instrumentation function) can be estimated.

Typically, one obtains the optimal set of parameters that satisfies a desired performance while minimizing the signals' word-length by an iterative process. Instead, according to the proposed method, one concentrates on how different fixed-point configurations, associated with different receiver conditions (scenarios), can provide important energy savings while keeping degradation to the system performance under control. For convenience, we restrict the exploration space to the traditional power-of-two word-lengths, encountered in most DSP architectures. Saturation arithmetic and rounding are also assumed.

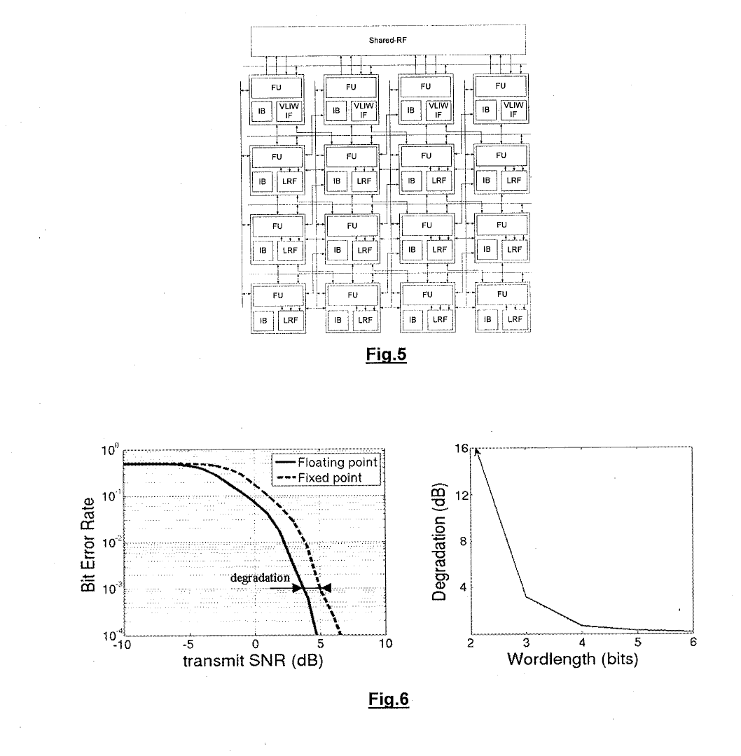

In order to properly steer the fixed-point refinement, an application performance indicator needs to be defined. The BER curve plots the ratio of erroneous bits received at different SNR conditions. Due to the finite precision effects, the BER curve experiences a shift to the right which is commonly referred to as implementation loss (see FIG. 6-left). The BER degradation is defined as the difference in SNR between the floating-point and the fixed-point representation at which the system delivers a given BER (for instance, 10⁻³). This is considered as the minimum performance required for a reliable transmission. Then the goal of the fixed-point refinement process is to reduce signal bit-width while keeping the BER degradation below a user-defined value. FIG. 6-right represents the BER degradation as function of the signal word-length. The curve monotonically grows with the bit reduction up to a point where reaches infinite degradation. This point indicates that the BER curve floors before the 10⁻³, and performance is not acceptable.

Following the proposed method, the different receiver modes/configurations are refined independently. In this example, all the configurations were assumed to have the same word-length along the different processing blocks. This reduces the overhead introduced by the inter-block shuffling operations. However, it also reduces the opportunity of having smaller word-lengths. During the fixed-point refinement, different BER degradation factors were also explored. Table III shows the resulting bit-widths. Notice that with a maximum BER degradation of 0.5 dB an important number of modes can be represented with half of the bits that are used in typical implementations. Moreover, the increase of BER degradation gradually enables even shorter word-lengths.

TABLE III

| | 0.5 dB | 1.5 dB | 2 dB |
|---|---|---|---|
| mode | [bits] | [bits] | [bits] |
| 1 | 8 | 8 | 4 |
| 2 | 8 | 8 | 8 |
| 3 | 8 | 8 | 8 |
| 4 | 8 | 8 | 8 |
| 5 | 8 | 8 | 8 |
| 6 | 8 | 8 | 8 |
| 7 | 16 | 8 | 8 |
| 8 | 16 | 16 | 8 |
| 9 | 8 | 8 | 8 |
| 10 | 8 | 8 | 8 |
| 11 | 8 | 8 | 8 |
| 12 | 8 | 8 | 8 |
| 13 | 16 | 8 | 8 |
| 14 | 16 | 16 | 16 |
| 15 | 16 | 16 | 16 |
| 16 | 16 | 16 | 16 |

The various modes of the receiver provide different trade-offs between raw data rate and noise robustness. Since a wireless receiver also experiences different SNR conditions depending on the specific moment, the mode that performs better under the given conditions should be selected. This selection is already done by the base station and the receiver controller just needs to identify the selected modulation mode (information included in the received preamble) and switch to the corresponding implementation at run-time.

Typically, in order to decide which mode is the most appropriate for a given SNR, the link adaptation procedure identifies the mode that achieves the highest average throughput at that SNR (FIG. 7 plots a reduced set for illustration purposes). The figure shows that the different receiver configurations have a SNR region where they outperform the others: A for the BPSK, B for the QPSK, C for the 16QAM and D for the 64QAM. We can assume that when the receiver is in a given SNR condition, the highest throughput configuration will be selected. From this the envelope of all the throughput curves can be defined as the system performance indicator. This approach also enables easy scenario detection at run-time.

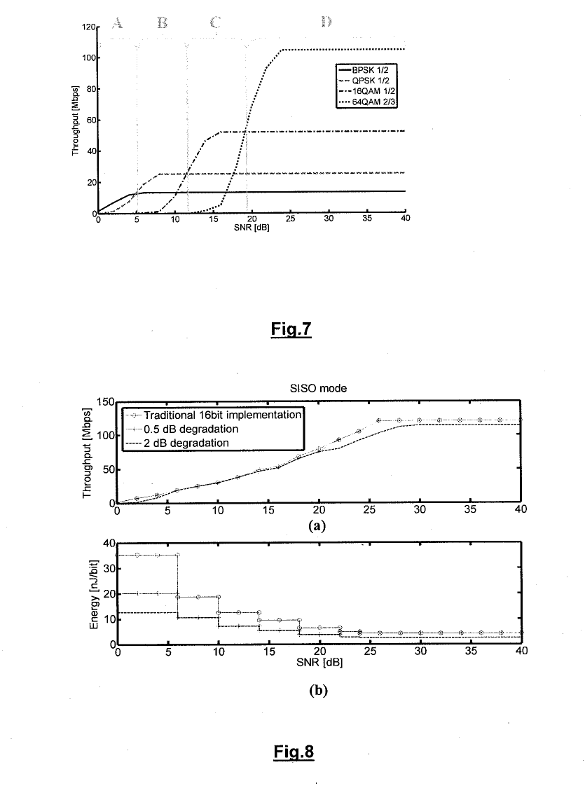

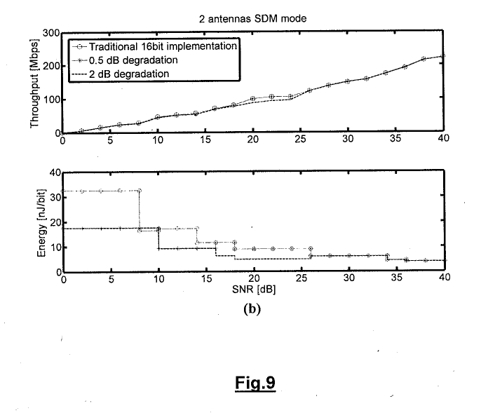

After splitting the application into the different scenarios, the inner receiver blocks previously introduced are implemented with the different resolutions indicated in Table III. The entire communication system can then be simulated and throughput curves extracted for the different implementations. Ideal synchronization and channel estimation is assumed. Following the proposed method, in this example, the set of scenarios (link adaptation) is defined for three different cases: a traditional all-modes 16 bit implementation (reference implementation since is the worst-case precision requirement) and a scenario-based data formatted implementation when allowing 0.5 and 2 dB BER degradation. The throughput envelope of the three cases considering the SISO (Single-Input Single-Output) and the 2 antennas SDM mode are plot in FIG. 8a and FIG. 9a respectively. In addition, their corresponding energy per transmitted bit, estimated by the flow described previously, is plot in FIG. 8b and FIG. 9b. One can observe that the low rate configurations consume more energy than the high rate ones. This can be easily understood since for transmitting the same amount of information, the low rate configurations need to send more OFDM symbols (due to the lower modulation order and/or lower coding rate). Consequently the processor needs to process during a longer time consuming more energy per bit of information.

When little BER degradation is allowed (e.g. less than 0.5 dB), negligible system performance loss is observed. However the energy per bit of the lower rate configurations is considerably reduced. For instance, in the region from 0-6 dB of the SISO case (see FIG. 8) the 16 bits sub-word implementation can be reduced to 8 bits resulting in a 43% energy saving. Due to the leakage power the reduction is slightly less than the ideal 50%. When more BER degradation is allowed (e.g. less than 2 dB), the performance starts to suffer. As an indicator, when less than 2 dB degradation is allowed and the receiver works with a 3 dB SNR, the maximum throughput drops by 53%. However a 4 bits implementation can now be accommodated, which reduces the energy by a 66%. In this case some performance is traded off by energy.

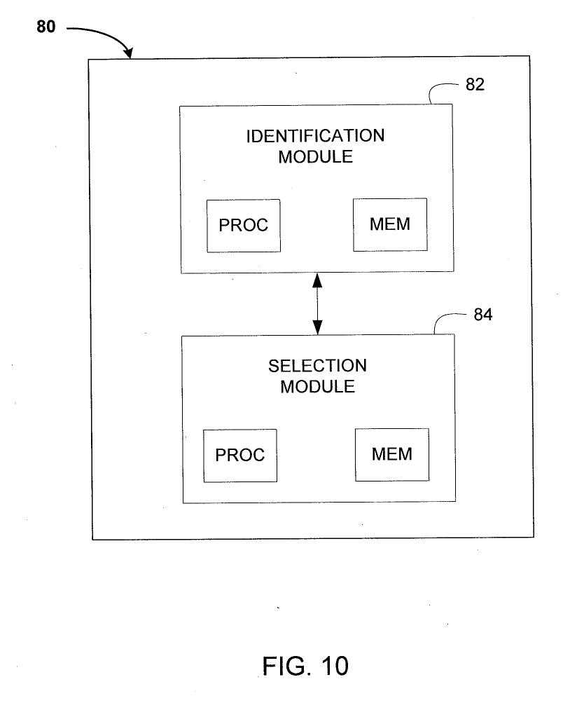

FIG. 10 shows a block diagram illustrating one embodiment of a communication device for transmitting data along a communication path. The device 80 comprises an identification module 82 configured to configured to identify at run-time an operational configuration based on received information on the communication conditions on the communication path. The system device 80 may further comprise a selection module 84 configured to select according to the identified operational configuration a data format for transmitting data among a plurality of predetermined data formats.

In one embodiment, the identification module and/or the selection module may optionally comprise a processor and/or a memory. In another embodiment, one or more processors and/or memories may be external to one or both modules. Furthermore, a computing environment may contain a plurality of computing resources which are in data communication.

Although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

It is to be noted that the processor or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product stored in a computer-readable medium for execution by a programmable processor. Method steps of aspects of the invention may be performed by a programmable processor executing instructions to perform functions of those aspects of the invention, e.g., by operating on input data and generating output data. Accordingly, the embodiment includes a computer program product which provides the functionality of any of the methods described above when executed on a computing device. Further, the embodiment includes a data carrier such as for example a CD-ROM or a diskette which stores the computer product in a machine-readable form and which executes at least one of the methods described above when executed on a computing device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the spirit and scope thereof. The present embodiments are therefore to be considered in all respects as illustrative and not restrictive, and all changes which come within the meaning and range of equivalency of these embodiments are therefore intended to be embraced therein. In other words, it is contemplated to cover any and all modifications, variations or equivalents that fall within the spirit and scope of the basic underlying principles. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means. The terms “first”, “second”, “third”, “a”, “b”, “c”, and the like, when used in the description are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of determining a data format for processing data to be transmitted along a communication path, the method comprising:
identifying at run-time an operational configuration based on received information on the conditions for communication on the communication path; and
selecting according to the identified operational configuration, a data format for processing data to be transmitted among a plurality of predetermined data formats.

2. The method of claim 1, wherein the process of identifying comprises mapping the identified operational configuration to one of a predetermined set of operational modes and wherein the data format is selected corresponding to the operational mode to which the operational configuration is mapped.

3. The method of claim 1, further comprising transmitting the data in the selected data format.

4. The method of claim 1, further comprising determining the information on the communication conditions on the communication path.

5. The method of claim 1, wherein the selected data format determines the word length of words in the data.

6. The method of claim 1, wherein the selected data format determines the fixed-point representation of the data.

7. The method of claim 1, wherein in the process of identifying the varying noise-robustness is taken into account exhibited by an application wherein the data is used.

8. The method of claim 1, wherein the method is performed on a single instruction multiple data processor.

9. The method according to claim 1, wherein the method is performed by one or more computing devices.

10. A communication device for transmitting data along a communication path, the device comprising:
an identification module configured to identify at run-time an operational configuration based on received information on the communication conditions on the communication path; and
a selection module configured to select according to the identified operational configuration a data format for transmitting data among a plurality of predetermined data formats.

11. The communication device of claim 10, further comprising a single instruction multiple data processor.

12. The communication device of claim 10, further comprising a hybrid single instruction multiple data-coarse grain array processor.

13. The communication device of claim 10, further comprising a computing device configured to execute at least one of the identification module and the selection module.

14. The communication device of claim 10, wherein the identification module is configured to map the identified operational configuration to one of a predetermined set of operational modes and wherein the selection module is configured to select a data format corresponding to the operational mode to which the operational configuration is mapped.

15. The communication device of claim 10, further comprising a transmission module configured to transmit the data in the selected data format.

16. The communication device of claim 10, further comprising a determining module configured to determine the information on the communication conditions on the communication path.

17. The communication device of claim 10, wherein the selected data format determines the word length of words in the data.

18. The communication device of claim 10, wherein the selected data format determines the fixed-point representation of the data.

19. The communication device of claim 10, wherein the identification module takes the varying noise-robustness into account exhibited by an application wherein the data is used.

20. A device for determining a data format for processing data to be transmitted along a communication path, the device comprising:
means for identifying at run-time an operational configuration based on received information on the conditions for communication on the communication path; and
means for selecting according to the identified operational configuration; a data format for processing data to be transmitted among a plurality of predetermined data formats.
